(19) United States
(12) Patent Application Publication
(10) Pub. No.: US 2008/0271584 A1
(43) Pub. Date: Nov. 6, 2008

(54) Quick assembling, disassembling and movement of components of a food slicing machine

(75) Inventor: Massimo Repaci, Basiglio (Milan) (IT)

Correspondence Address: HEDMAN & COSTIGAN P.C., 1185 AVENUE OF THE AMERICAS, NEW YORK, NY, 10036, US

(73) Assignee: BERKEL S.P.A, MILAN (IT)

(21) Appl. No.: 12/150,390

(22) Filed: Apr. 28, 2008

(30) Foreign Application Priority Data
May 4, 2007 (IT) MI2007A 000899

(51) Int. Cl. B26D 7/01; A47J 43/04; B26D 7/00; B21K 5/12; B26D 7/22

(52) U.S. Cl. 83/471; 99/537; 83/478; 83/648; 76/82

(57) ABSTRACT

Herein described is a quick assembling disassembling and movement mechanism for a component of a food slicing machine (10) of the type comprising a framework (12) bearing a rotating blade (14), provided with a blade-cover (16) which extends for at least a part of the circumferential edge of the blade (14), a moveable flap (18) and guide means (20) for a carriage (22). The carriage (22) is made up of a product-bearing plate (24), a support arm (26), constrained in a sliding manner against the guide means (20), and a cover-plate (28) sliding over the product-bearing plate (24) in an orthogonal direction with respect to the moveable flap (18). The mechanism comprises at least one operation lever (32), hinged against the framework (12) or against the support arm (26), capable of operating, through one or more levers (34), one or more coupling elements (36) which keep the component constrained against the framework (12) when the lever (32) is operated and which allow the movement of the component when the lever (32) is not operated.

The present invention refers to a food slicing machine and, more in particular, to a quick assembly, disassembly and movement mechanism of components of a food slicing machine of the rotating blade type.

These food slicing machines are known in various versions and are provided with a circular rotating blade, operated in most cases by an electric motor, used for slicing food products at variable thicknesses. Such food slicing machines are mainly characterised by vertical machines, in which the product is pushed horizontally towards the blade, and the so-called gravity machines, in which the product to be cut is moved towards the blade due to gravity effect. Usually, the blade is supported by an arm integrally joined with a framework, to which associated in a sliding manner is a carriage for holding and laying the product to be sliced. Such carriage can be slid, manually or automatically, following a radial direction with respect to the circular blade in such a manner to obtain, upon each translational movement towards the blade, the cutting of product slice.

The various components of a food slicing machine, such as for example the plate on which the product to be sliced is laid, the protection cover of the blade or the sharpening device of the blade itself, must be assembled and disassembled on site for cleaning and/or maintenance purposes, both ordinary and extraordinary. The removal of professional food slicing devices components complying with the EC standards in force, must comply with the UNI-EN 1974 regulation entitled “Food processing machinery—slicing machines—safety and hygiene requirements”. In order to comply with the abovementioned regulation, the food slicing machines currently in the market adopt various solutions for assembling and disassembling their components.

In some types of food slicing machines known, the removal of the support group of the products to be sliced, the cutting group and/or the sharpening device as well as its related cover, is possible only by means of specific tools and it can thus be performed, often in a complicated manner and requiring a lot of time, only at non-ordinary maintenance level.

In other cases, the removal of the components of a food slicing machine can be performed without requiring tools, that is by means of suitable knobs, external with respect to the body of the machine, which operate on threaded connection and fastening elements. However, given that these threaded elements are coupled in corresponding threaded holes provided on the body of the machine, discontinuities problems arise leading to difficulties when it comes to cleaning and hence potential concentration of bacterial content. Furthermore, the external knobs are usually fastened and unfastened manually through a considerable number of rotations, consequently implying a substantial waste of time when performing cleaning and sanitising operations on the food slicing machine which, according to the manufacturers' instructions, should be performed on daily basis.

Additionally, some of the components of the food slicing machine, among which for example the sharpening device and the thickness gauge plane adjustment device, require to be moved in such a manner to ensure the safety, reliability, repeatability of the operations for the user and that the machine be easy to handle.

In some types of food slicing machines known, the positioning of the sharpening device at operation status is performed through an elaborate and complex movement. In other cases, such movement operation might expose the user to the risk of getting into contact with the exposed area of blade, that is with its sharpened portion.

Furthermore, regarding the thickness gauge adjustment plane, in most of the food slicing machines, such device does not provide a value accurately corresponding to the value appearing on the adjustment knob indicator, due to the use of false values indicated on said knob, or due to the fact that, in other types of machines, multiple rotations of the knob are required in order to reach the maximum thickness.

Therefore, an objective of the present invention is that of providing a quick assembling disassembling and movement mechanism of a component of a food slicing machine capable of facilitating the performance of the removal and reassembly operations of the component in question through a single, simple and easy operation movement.

Another objective of the invention is that of providing a quick assembling, disassembling and movement mechanism of components of a food slicing machine which allows to obtain a better sanitisation of the component in question and of the machine itself, due to its smaller dimensions and lighter weight to be moved as well as the absence of holes on the framework of the machine.

Further objective of the present invention is that of providing a quick assembling, disassembling and movement mechanism of components of a food slicing machine capable of being integrated in the general design and ergonomics of the machine itself, being concealable but easily accessible for maintenance and not having any projections external with respect to the body of the machine.

Still, another objective of the invention is that of providing a quick assembling, disassembling and movement mechanism of components of a food slicing machine capable of allowing a quick, intuitive, safe movement, in particular of the sharpening device, (not exposing the user to risks) and integrated in the general design and ergonomics of the machine itself.

Lastly, further objective of the present invention is that of providing a quick assembling, disassembling and movement mechanism of components of a food slicing machine capable of allowing an adjustment, in particular the adjustment of the thickness gauge plane, in such a manner to allow setting the maximum thickness of a slice to be cut through a single rotation of the adjustment knob, a differentiated adjustment within the range of rotation capable of providing greater accuracy on the minimum thicknesses and a product thickness corresponding to the direct and actual value appearing on the knob indicator itself.

These objectives according to the present invention are attained by providing a quick assembling, disassembling and movement mechanism of the components of a food slicing machine as described in claim 1.

Further characteristics of the invention are outlined by the subsequent claims.

Characteristics and advantages of a quick assembling, disassembling and movement mechanism of the components of a food slicing machine according to the present invention shall be clearer from the following exemplifying and non-limiting description provided with reference to the schematic drawings wherein:

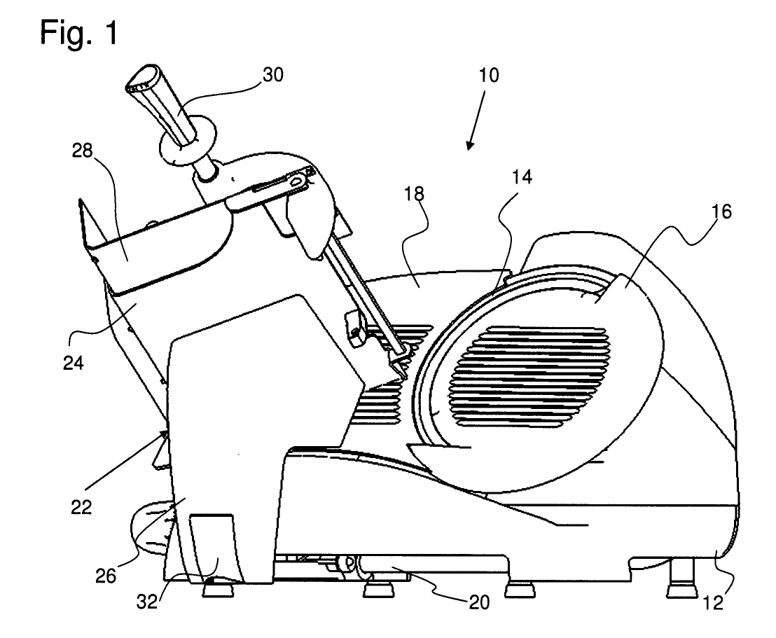

FIG. 1 is a perspective view of a food slicing machine provided with a quick assembling, disassembling and movement mechanism of the components according to the invention;

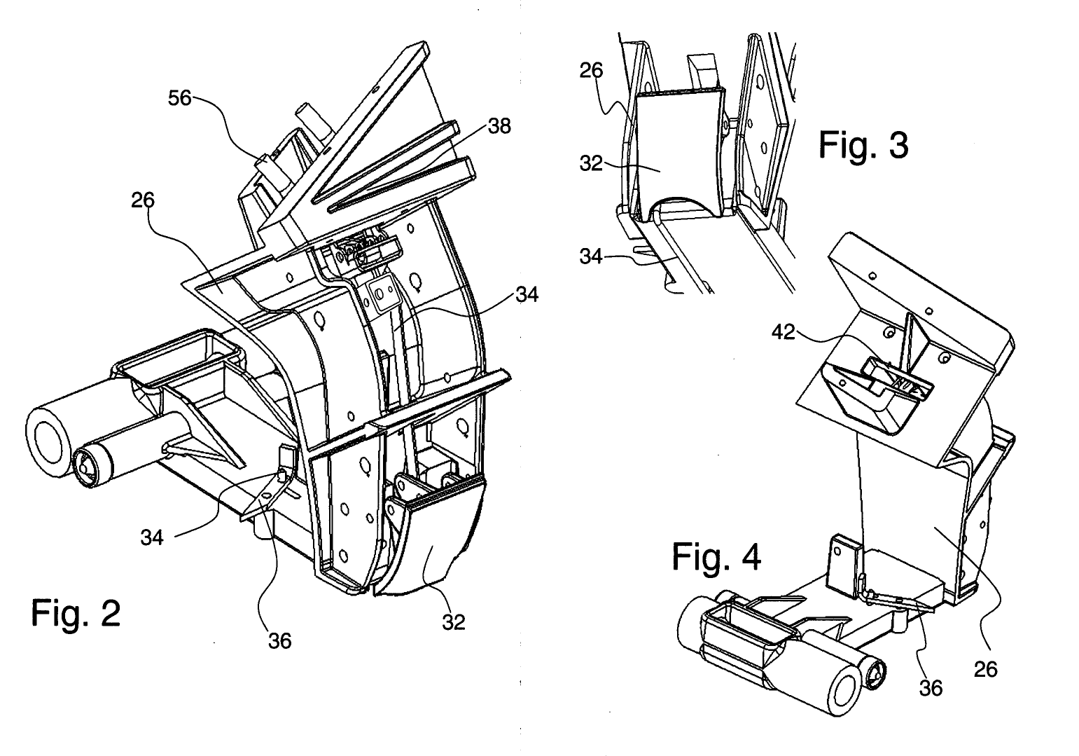

FIG. 2 is a transparent perspective view of a first embodiment of the quick assembling, disassembling and movement mechanism according to the invention, applied on a support arm of the product-bearing plate of the food slicing machine;

FIG. 3 is a perspective view of the control lever of the mechanism of FIG. 2;

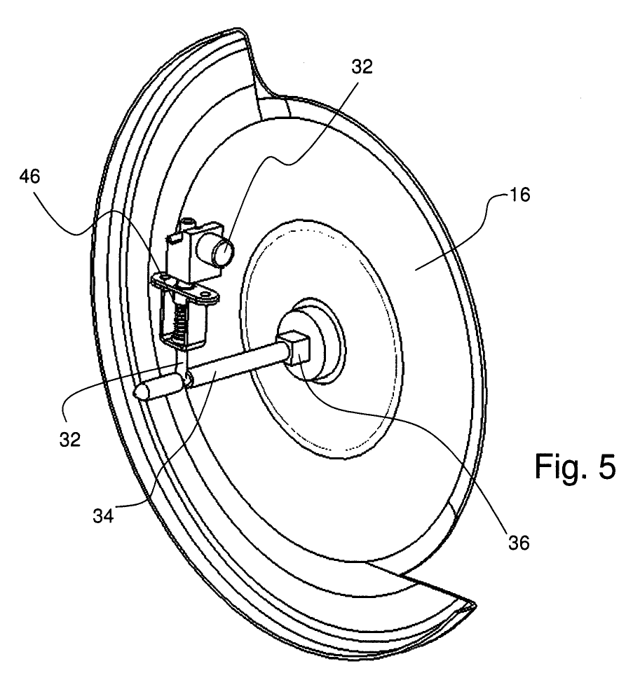

FIG. 4 is a further perspective view of the mechanism of FIG. 2;

FIG. 5 is a perspective view of a second embodiment of a quick assembling, disassembling and movement mechanism according to the invention applied to the cover of the rotating blade of the food slicing machine;

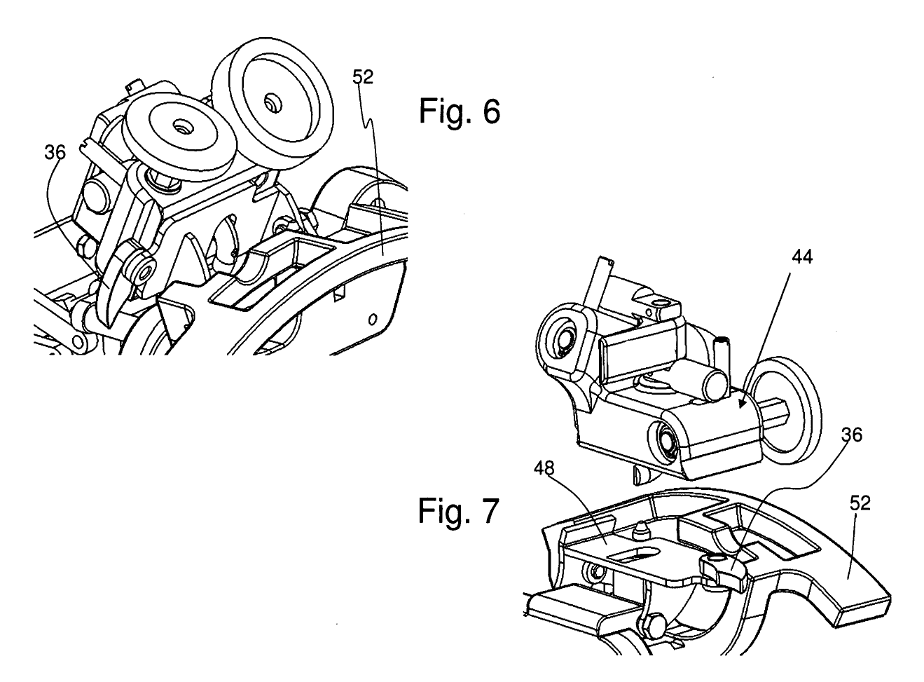

FIGS. 6-7 are perspective views of a further embodiment of a quick assembling and disassembling mechanism, according to the invention, applied to the sharpening device of the rotating blade of the food slicing machine.

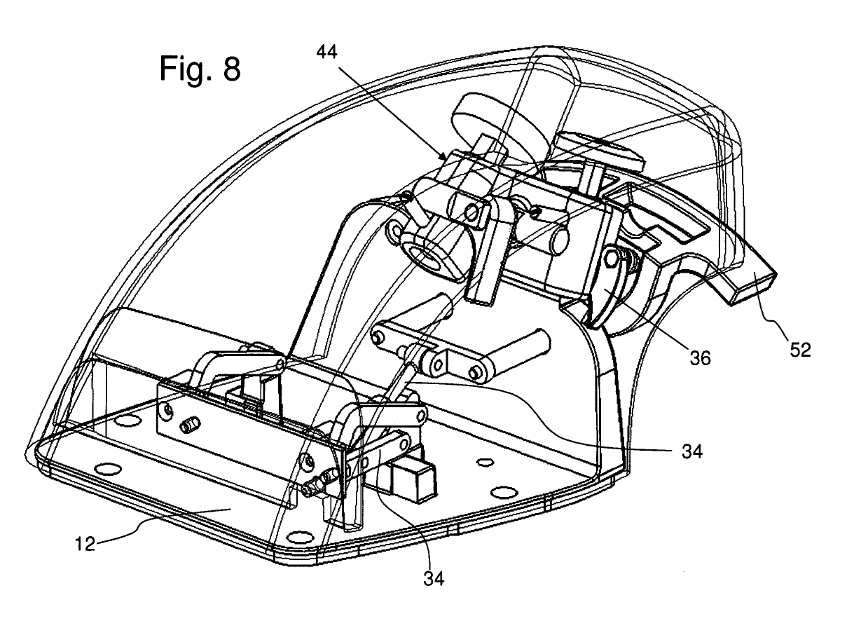

FIG. 8 is a perspective view of a first embodiment of a quick movement mechanism according to the invention applied to the sharpening device of the food slicing machine; and

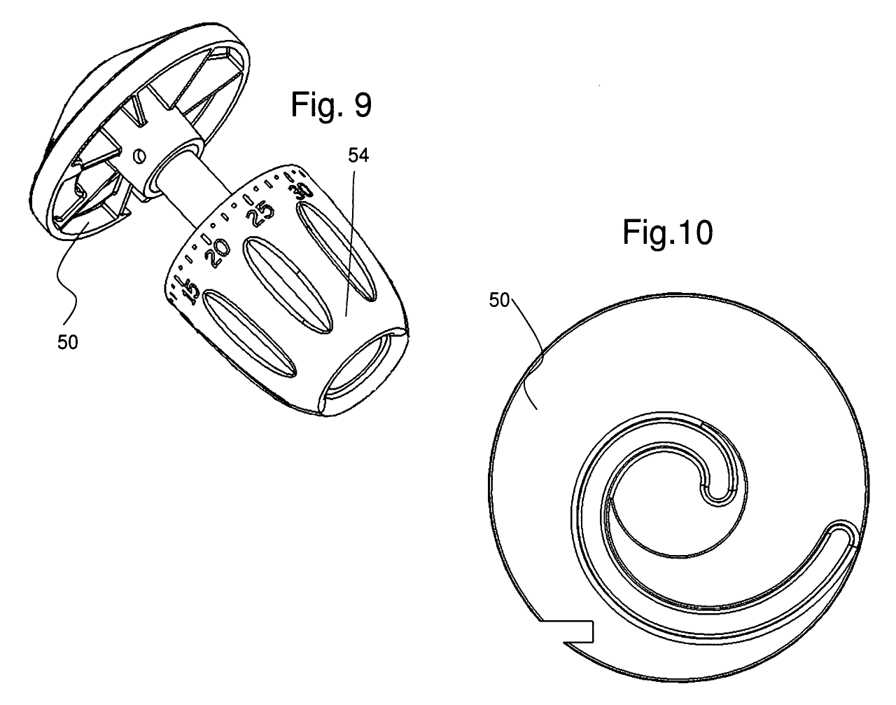

FIGS. 9 and 10 are respectively a perspective and a side elevated view of a second embodiment of a quick movement mechanism according to the invention, applied to the thickness adjustment device of the food slicing machine.

Referring in particular to FIG. 1, illustrated is an overall view of a food slicing machine, indicated in its entirety with reference number 10. The food slicing machine 10 comprises a framework 12 which, in a per se known manner, bears a rotating blade 14 operated by a motor associated to the framework 12 itself. For safety reasons, the blade 14 is provided with a shield or blade-cover 16 which extends for at least part of the circumferential edge of the blade 14 itself and which ends at a cutting zone, where provided is a moveable flap 18, or a thickness gauge plane, against which the product to be sliced is pushed. The position of the thickness gauge plane 18 with respect to the blade 14 is adjusted by a slice thickness adjustment device which allows to obtain the desired thickness of the slices themselves during the cutting operations.

Thus, provided on the framework 12 are guide means 20 for the sliding of a carriage 22 made up of a product-bearing plate 24, a corresponding support arm 26, constrained in a sliding manner against the guide means 20, a cover-plate 28, sliding over the product-bearing plate 24 in an orthogonal direction with respect to the thickness gauge plane 18 and on which the product to be sliced is laid, and a pressure element 30, rotatable with respect to the cover-plate 28, used to push the product on the product-bearing plate 24 towards the thickness gauge plane 18.

In addition, the food slicing machine 10 can be provided with a blade 14 sharpening device 44, schematically shown in FIGS. 7 and 8. The sharpening device 44 is of the type per se known to the prior art and thus shall not be described in detail.

According to the invention, the quick assembly and disassembly mechanism, applicable for example to the blade-cover 16, the product-bearing plate 24 and/or the blade 14 sharpening device 44 for its removal from the framework 12 of the machine 10 for cleaning and maintenance operations is primarily made up of an operation lever 32 hinged against the framework 12 of the machine 10 or, in case the component to be disassembled is for example a product-bearing plate 24, against the related support arm 26 (as shown in FIGS. 2-4), or still, in cases where the component to be disassembled is the sharpening device, provided with a support fork 48. In the specific case of the product-bearing plate 24, the lever 32 is capable of operating through a series of levers 34, one or more coupling elements 36 which keep the component constrained against the framework 12 when the lever 32 is operated but which allow the sliding of the component itself when the lever 32 is not operated.

According to the embodiment illustrated in FIGS. 2-4, the mechanism according to the invention is capable of decoupling the group made up of the product-loading plate 24, the cover-plate 28 and the pressure element 30 from the related support arm 26. For safety reasons, such decoupling operation is possible only when the thickness gauge plane 18 is closed and the product movement carriage 22 is at the stroke start position, that is at the maximum distance from the blade 14. The mechanism according to the invention is thus capable of blocking, at the same time with the decoupling step of the component in question, the thickness gauge plane 18 at its closure position and the carriage 22 at its stroke start position.

When removing, by means of the mechanism illustrated in FIGS. 2-4, the group made up of the product-bearing plate 24, the cover-plate 28 and the pressure element 30, the slot 42 provided at the end of the support arm 26, which serves as a coupling and centring seat for a corresponding bent pin 56 of the product-bearing plate 24 according to the illustrated embodiment, is closed completely, to avoid entry of liquids or foreign bodies. The closure of the slot 42 is performed by means of a metal component 38, whose closure rotation and positioning are performed in a synchronous and automatic manner with the removal of the component, operated by the levers 34.

FIGS. 6 and 7 show further embodiments of the quick assembling and disassembling mechanism according to the invention respectively applied to a blade-cover 16 and to the blade 14 sharpening device 44 of the food slicing machine 10. In this case too, it is possible to decouple the blade-cover 16 from the framework 12 and/or move the sharpening device 44 from its operation position to allow the maintenance and cleaning operations of the same but without exposing the user to risks of contact with the sharpened end of the blade 14, due to the aid of a suitably shaped section 52, which constantly shields the blade 14 itself. One or more elastic elements 46 capable of facilitating the assembling and disassembling operations of the component in question can be operatively connected to the operation lever 32 as shown in FIG. 5.

Upon completion of the cleaning and maintenance operations of the component or components in question, once the latter have been properly repositioned on their supports, they are automatically blocked at operating positions by operating a lever 32 operatively connected to the levers 34. As a matter of fact the operation lever 32 is moved back to the closure position, the initial position and the coupling are restored, by reinstating the coupling element 36, between the component and its support and the food slicing machine 10 is consequently reconfigured to its operation status.

The operation lever 32 can also be provided with a locking button (not shown) which allows, when used, to return the operation lever 32 automatically to the closure position, restoring the initial positioning and coupling, by reinstating the coupling element 36, between the component and its support as well as reconfiguring the food slicing machine 10 to its operation status.

On the other hand, referring to FIG. 8, provided is an illustration of how, due to the levers 34 operated by the lever 32, a quick movement of the sharpening device 44 of the food slicing machine 10 can be performed. The levers 34 allow to move the sharpening device 44 from the idle position to the operation position (and vice versa) without exposing the user performing this operation to any risk, by means of a section 52 which shields against any inadvertent contact with the blade 14 also through the operation movement of the entire kinematism, which allows to keep the user's hand at a safe distance with respect to the rotating blade 14.

According to the invention, a further mechanism for the quick movement, shown in FIGS. 9 and 10, is made up of the adjustment means for positioning the thickness gauge plane 18 with respect to the blade 14. Such adjustment means comprise a knob 54 and a spiral cam 50 operatively connected to each other, which allow the user to perform an accurate, repeatable and actual adjustment of the thickness of the product slice. As a matter of fact, the thickness is expressed in millimetres, through direct silkscreen printing of a millimetre gauge on the knob 54.

The shape of the route of the spiral cam 50, due to a suitable calibrated mathematical principle, allows a progressive and differentiated opening of the thickness gauge plane 18 upon the rotation of the of the cam 50 itself, providing greater accuracy in terms of the minimum thicknesses of the product slices. Hence, the spiral cam 50 allows obtaining a differentiated accuracy (greater for minimum thicknesses, lower for maximum thicknesses) on the rotation and obtaining the maximum sliceable thickness (a 32 mm thick slice) through a single rotation.

It has thus been observed that a quick assembling, disassembling and movement mechanism of components of a food slicing machine according to the present invention attains the previously outlined objectives allowing, through a single movement of the operation lever, easy and quick removal of a component or group of components from the framework of the machine and to reassemble such component in an equally quick and safe manner. Additionally, the possibility to cover, where provided for, the coupling and centring holes of the component allows to obtain a better sanitisation of the food slicing machine.

Furthermore, the mechanism according to the invention allows to move a component, or groups of components of the food slicing machine from the respective idle position to the operation position (and vice versa) in an easy, quick and accurate manner.

The quick assembling, disassembling and movement mechanism of components of a food slicing machine of the present invention thus conceived is in any case susceptible to various modifications and variants, all falling within the same invention concept; furthermore, all the details can be replaced by other technically equivalent elements. In practice, the material used, alongside their dimensions, may vary depending of the technical requirements.

Thus, the scope of protection of the invention is outlined by the attached claims.

1. Quick assembling, disassembling and movement mechanism of components of a food slicing machine (10) of the type comprising a framework (12) bearing a rotating blade (14), provided with a blade-cover (16) which extends for at least part of the circumferential edge of said blade (14), a moveable flap (18) and guide means (20) for a carriage (22) made up of a product-bearing plate (24), a support arm (26) constrained in a sliding manner against said guide means (20), and a cover-plate (28) sliding over said product-bearing plate (24) in an orthogonal direction with respect to said moveable flap (18), the mechanism being characterised by the fact that it comprises at least one operation lever (32), hinged against said framework (12) or against said support arm (26), said lever (32) being capable of operating, through one or more levers (34), one or more coupling elements (36) which keep said component constrained against said framework (12) when said lever (32) is operated and which allows the movement of said component when said lever (32) is not operated.

2. Mechanism according to claim 1, characterised in that said component of said food slicing machine (10) is made up of a group comprising said product-bearing plate (24), said cover-plate (28) and by a pressure element (30) for the product to be sliced, rotatable with respect to said cover-plate (28).

3. Mechanism according to claim 1, characterised in that said component of said food slicing machine (10) is made up of said blade-cover (16).

4. Mechanism according to claim 1, characterised in that said component of said food slicing machine (10) is made up of a sharpening device (44) for said blade (14).

5. Mechanism according to claim 2, further comprising at least one button arranged at said operation lever (32) and operatively connected to said levers (34), said button operating said coupling element (36) constraining said component against said framework (12) upon operation of said lever (32).

6. Mechanism according to claim 3, further comprising one or more elastic components (46) operatively connected to said operation lever (32) and/or to said levers (34) to facilitate assembling and disassembling operations of said blade-cover (16).

7. Mechanism according to claim 2, further comprising one or more metal components (38) operated by said levers (34) to perform the closure of the respective slots (42), provided at the end of said support arm (26), which serve as coupling and centring seats for said product-bearing plate (24).

8. Mechanism according to claim 4, characterised in that said sharpening device (44) is provided with at least one shaped section element (52) which shields the user against any inadvertent contact with said rotating blade (14).

9. Mechanism according to claim 1, further comprising means (50, 54) for adjusting the position of said moveable flap (18) with respect to said rotating blade (14).

10. Mechanism according to claim 9, characterised in that said adjustment means comprise a knob (54) and a spiral cam (50) operatively connected to each other, the shape of the route of said spiral cam (50) allowing a progressive and differential opening of said moveable flap (18) upon the rotation of said spiral cam (50).
